(19) United States
(12) Patent Application Publication
(10) Pub. No.: US 2011/0030524 A1
(43) Pub. Date: Feb. 10, 2011

(54) CUTTING APPARATUS

(76) Inventor: Kevin Ross Inkster, Western Australia (AU)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/744,147

(22) PCT Filed: Nov. 24, 2008
(86) PCT No.: PCT/AU08/01735

§ 371 Date: Nov. 1, 2010

(30) Foreign Application Priority Data
Nov. 23, 2007 (AU) 2007906434

(51) Int. Cl. B26D 1/24

(52) U.S. Cl. 83/495

(57) ABSTRACT

A cutting apparatus of a type where two juxtaposed blades are caused to move through sequential approximately elliptical paths and having teeth at respective outer edges of the two juxtaposed blades the relatively moving teeth on the edge of the respective blades being adapted to be urged against a surface to b cut, and at least one anchoring locator which is positioned beyond a periphery of the respective blades and thereby adapted to engage with a work piece while it is being cut and provide thereby a potential anchoring position for a work piece.

This invention relates to a cutting apparatus and in particular to a cutting arrangement where two juxtaposed blades are caused to move sequential approximately elliptical paths.

### BACKGROUND OF THE INVENTION

The cutting action that I have described is described in my earlier patent one example of which is U.S. Pat. No. 5456011 filed 12 Oct. 1993.

Cutting is achieved using the described action by having teeth on respective outer edges of the two juxtaposed blades and then urging the relatively moving teeth on the edge of the respective blades against a surface to be cut.

In practice, using such a cutting arrangement with blades that project to a respective cutting edge will, because of the mechanism controlling the geometry of the cutting action, exhibit differing elliptical paths and differently orientated elliptical paths as one progresses from location to location around the cutting edge.

The effect of this is that cutting, using the system, involves an operator holding the cutting apparatus and pulling the relatively moving cutting edges of the blades through a cutting stroke.

This in part requires strength in holding and pushing down to have the cutting edge of the blades engage with adequate pressure against the surface being cut but also requires further strength in being able to effect rotation of the blades through a cutting slot so that some part of the cutting edges will be brought to bear against a surface to be cut where perhaps there is a more appropriately angled elliptical or approximately elliptical path for effecting such cutting.

However, such actions can be awkward and tiring and an object of this invention is to provide for an arrangement and method of operating machinery that will be of advantage over what currently exists.

### BRIEF SUMMARY OF THE INVENTION

My proposal is, in relation to a cutting apparatus as previously described, to provide an anchoring locator or locators which can engage with a work piece while it is being cut and provide thereby a potential pivot position about which the apparatus can be turned and effect a shifting of the position of the moving blades about such pivot locator.

This is achieved in one instance by having a member attached to the body of the apparatus and extending to one side at least of the blades and extending further than the peripheral alignment of a cutting edge of the respective blades, and there being provided at such distal location, an anchoring locator.

In preference, such anchoring locator is a sharp tooth which is adapted to ensnare and provide a pivot location point by engaging against a work piece as it is being cut by the relatively moving blades. In preference such sharp tooth is shaped and positioned to provide an anchoring location for many instances of work piece type, size and shape.

In preference, the member includes at least two anchor point locators at least one of which is inboard from adjacent cutting edges of the respective cutting blades.

In preference, the position of the anchoring locators include a plurality of locators where at least one is beyond the perimeter of the cutting edges of the juxtaposed blades and at least two anchoring locations which are spaced apart are located inboard from the cutting edges of the juxtaposed blades.

While reference so far has been made to a single member and this is able to be attached anywhere to the body, there is advantage in having two members or two parts of a single member secured to the body but each extending, a first member or part along one side of the blades, and the other member or part to the other side of the blades and each providing mutually aligned anchoring locators.

An advantage of having two members or parts with mutually aligned anchoring locations in the first instance is that both anchoring locators engaging against a work piece, when the work piece is being out at a mutually perpendicular alignment, then both anchoring locators which is to say one to each side provide a stabilizing support and help to hold an alignment of the cutting blades.

An incidental advantage of two members each extending beyond the cutting edge of the blades, is also that these can then act to support the cutting apparatus as a whole so that on a planar surface, the outer ends of the members can rest upon the planar support surface with a remainder of the body resting otherwise on the surface and teeth of the respective blades also being held above the surface.

In preference, the anchoring locator or, locators positioned beyond the periphery of the cutting edges are positioned at or toward one end of the cutting edges of the blade where the major axes of the approximately elliptical path of the respective cutting edges of the blades are approximately aligned with the alignment of the cutting edge, and this compares to the other end of the blades cutting edges where the alignment of the cutting edge is closer to alignment of a major axis of the approximate elliptical path of the respective cutting edges.

In preference, there are provided a plurality of anchor locators which are spaced at spaced apart locations of the member (or each part) extending from an outer locator position with respect to the cutting edges and then extending in a concave alignment with at least a further anchor locator positioned closest to a body of the cutting apparatus and relatively equal distant from the respective two outer end of the cutting edges of each respective blade.

While an anchoring locator in one position beyond a periphery of the cutting edges of the respective blades is in a preferred example a sharp point, in a further location around the periphery of the cutting edges of the blades where the relative movement of the teeth at this location may be close to or tangential to the curve of the respective cutting edges at this location, an anchoring locator can then be an edge that provides a relatively linear surface which extends approximately at least in a transverse alignment of the path of the respective teeth of the cutting edges.

In a further form of the invention, although this need not necessarily be the only or indeed the broadest form of this, there is provided a cutting tool having a body, the first blade secured at a first location to a link secured to the body and arranged to allow constrained relative motion to the body, the first blade being further secured to the body by a first pivot connection which itself is secured to a rotatable drive adapted to provide an oscillatory motion to the blade in a direction co-planar with the plane of the blade relative to the body, the first blade having an outer cutting edge with teeth, the cutting edge being spaced apart from an axis of the rotatable drive, and spaced apart further from said first location, the cutting edge being of convex arcuate shape having an approximate radius with a radial centre being an axis through an outermost position of the central axis of its connection with the rotatable drive, and its extent being from a position approximately aligned with the said first location and the said axis through an outermost position of the central axis of its connection with the rotatable drive, and extending around to approximately a position where it is aligned at approximately 45° to said first radius, a second blade secured at a second location to a second link secured to the body and arranged to allow constrained relative movement to the body, the second blade being further secured to the body by a second pivot connection which itself is secured to a rotatable drive adapted to provide an oscillatory motion to the blade in a direction parallel with the plane of the blade relative to the body, the second blade having an outer cutting edge with teeth, the cutting edge being spaced apart from the axis of the rotatable drive, and spaced apart further from the said second location, the cutting edge being of convex arcuate shape having an approximate radius with a radial centre being the axis through an outermost position of the central axis of its connection with the rotatable drive, and its extent being from a position approximately aligned with the said second location and the said axis through an outermost position of the central axis of its connection with the rotatable drive, and extending around to approximately a position where it is aligned at approximately 45° to the said second radius, the first and second blades being shaped and supported relative to the body so that each cutting surface is restrained to move in an elliptical path the one being with an action that is out of phase compared to the action of the other, and having the cutting edges in a co-operatively mutually aligned cutting relation, a member secured to the body and extending to provide a first anchor locator which is positioned to be further out from the body than the respective cutting edges of the respective adjacent blades, and having further anchor locators positioned closer to the body than the outer cutting edges of the respective blades.

In an alternative description of the arrangement, there is provided a cutting tool comprising two juxtaposed cutting members each having a tooth cutting edge of a substantially same shape and extent, each of said cutting members having a drive portion extending in a direction lateral to the cutting edge, said drive portions being in a juxtaposed relation;

a drive means adapted for coupling to a motor and operatively interacting with each said drive portion to impart thereto an eccentric movement in a plane of each respective said drive portion about a common axis, the eccentric movement imparted to the respective drive portions being equal and angularly out of phase; and

means to restrain movement of the respective drive portions at a specific location spaced from said common axis to a approximately linear movement in a direction radial to the common axis and to angular movement about a respectively pivot axis parallel to said common axis, whereby in response to activation of the drive means, the cutting edge of each cutting member prescribes, in a plane of the cutting member, simultaneous oscillatory movements in the direction of the cutting edge and in a direction substantially at right angles to the cutting edge, the corresponding movements of the respective cutting members being outer phase, and the teeth of the cutting edge being adapted to each cut when moving individually in one direction in the direction of the extent of the cutting edge, and a member located to a side of the respective cutting members and providing an anchor locator shape which is positioned beyond the position of the cutting edges of each respective blade.

In preference there are two members with aligned anchor locating shapes positioned one to each side of the blades.

### DISCLOSURE OF THE INVENTION

For a better understanding of the invention it will now be described in relation to an embodiment which shall be described with the assistance of drawings wherein:

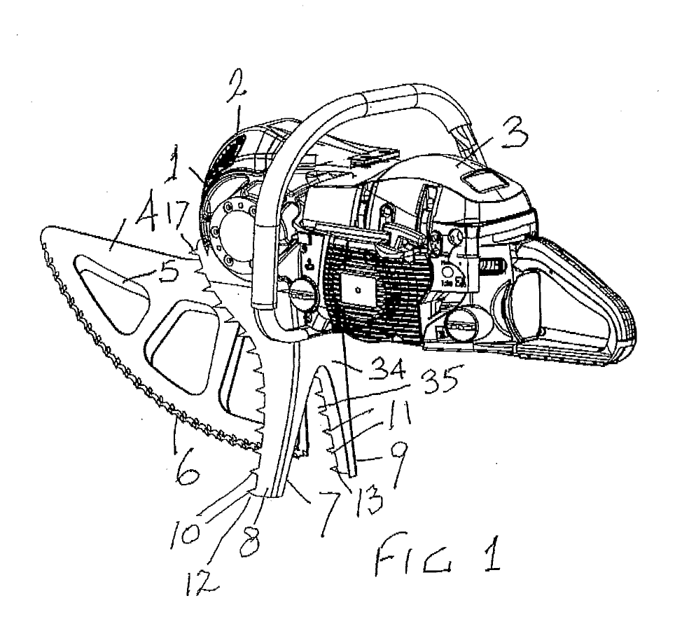

FIG. 1 is a perspective view of a cutting apparatus incorporating the embodiment of the invention the view being from slightly behind and above the cutting arrangement;

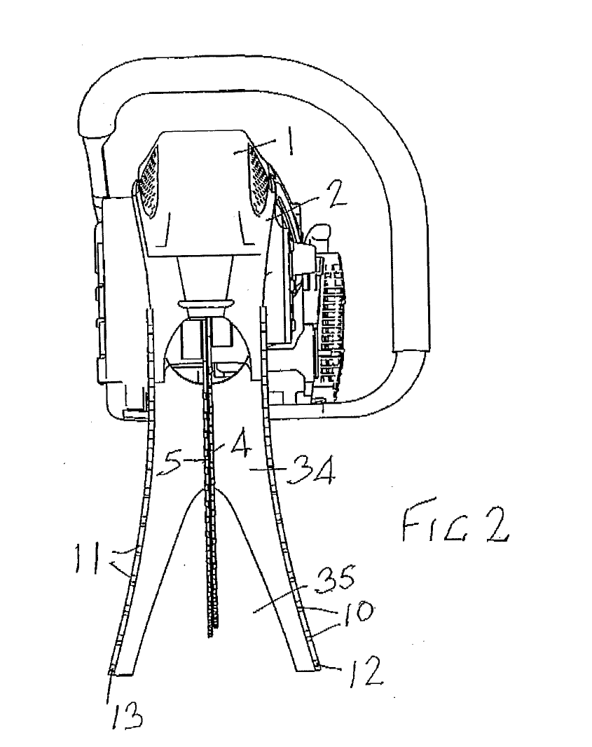

FIG. 2 is a view of the same embodiment as in FIG. 1 but being viewed from directly in front of the arrangement;

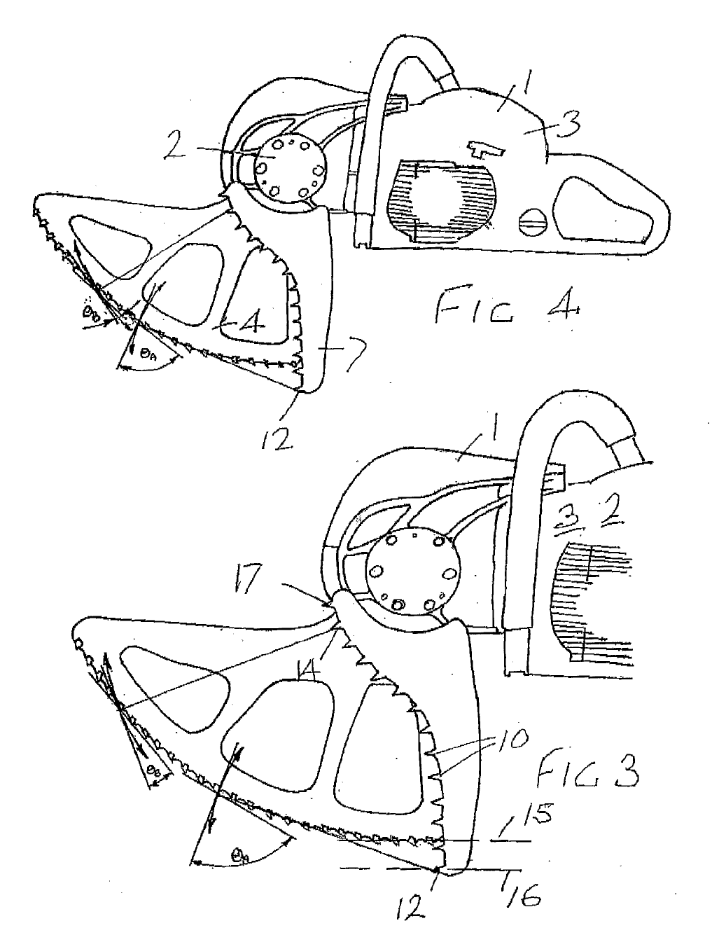

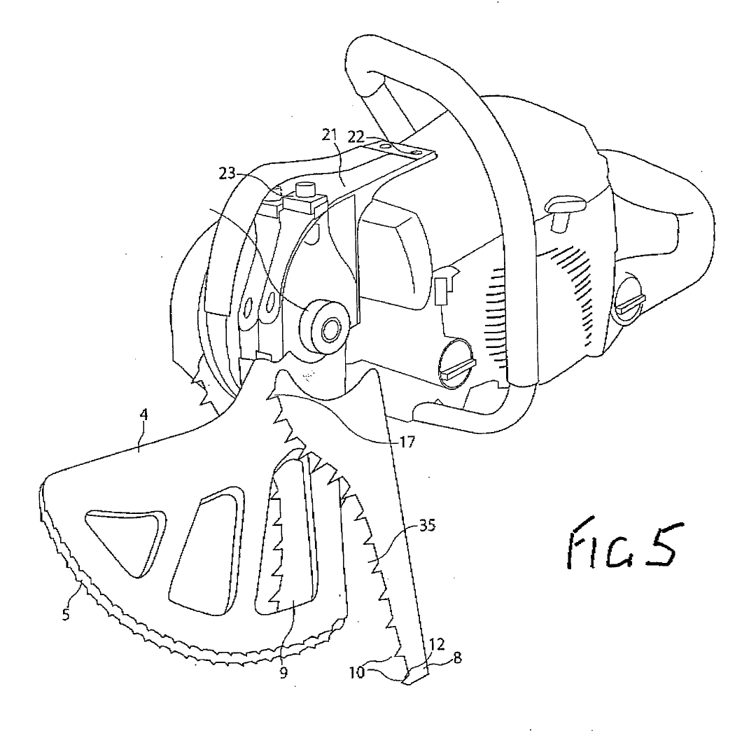

FIG. 3 and FIG. 4 are both side views shown now more schematically with the views in each case being from a side and illustrating relative teeth paths with relation to anchor locations provided by the respective teeth of the jaw;

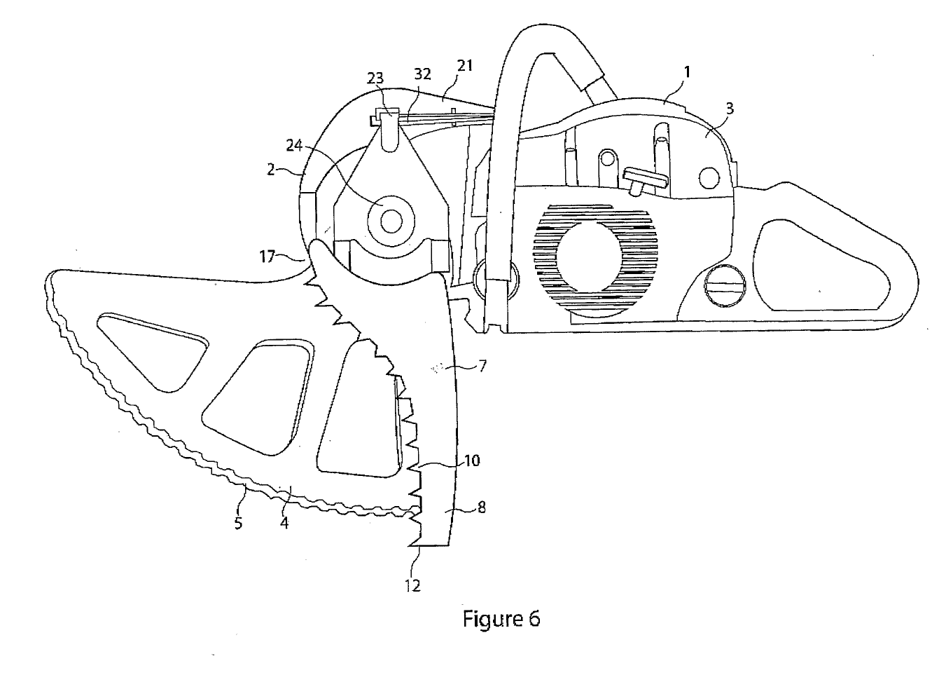

FIG. 5 is a view partly cut away and being in perspective from in front and to a side of the cutting arrangement illustrating also however the support arrangement in part providing the cutting action of the blades;

FIG. 6 is a side view of the same cut away view as shown in FIG. 5;

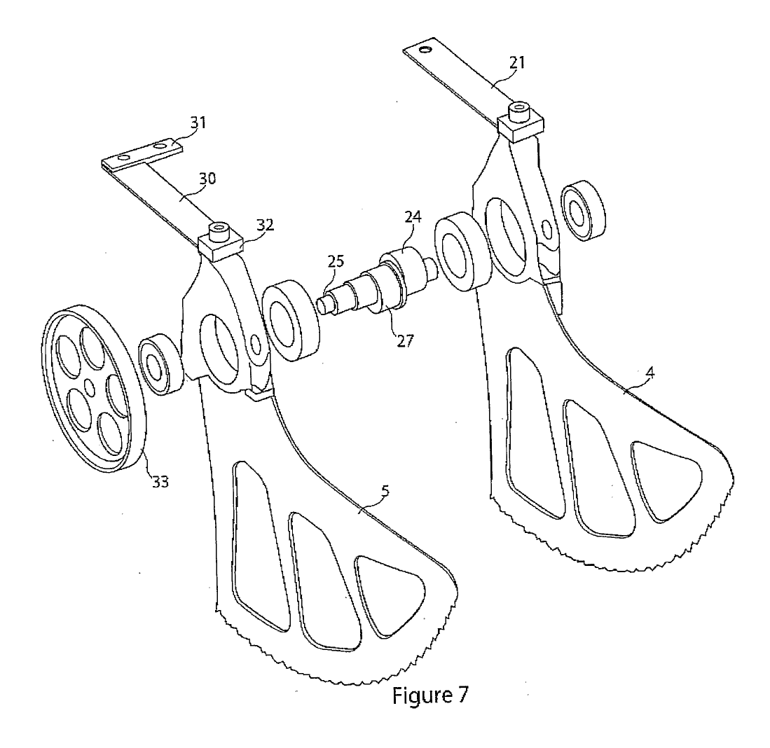

FIG. 7 is an exploded view of the operating parts connecting and effecting the movement of the respective blades but not in this case including the jaws;

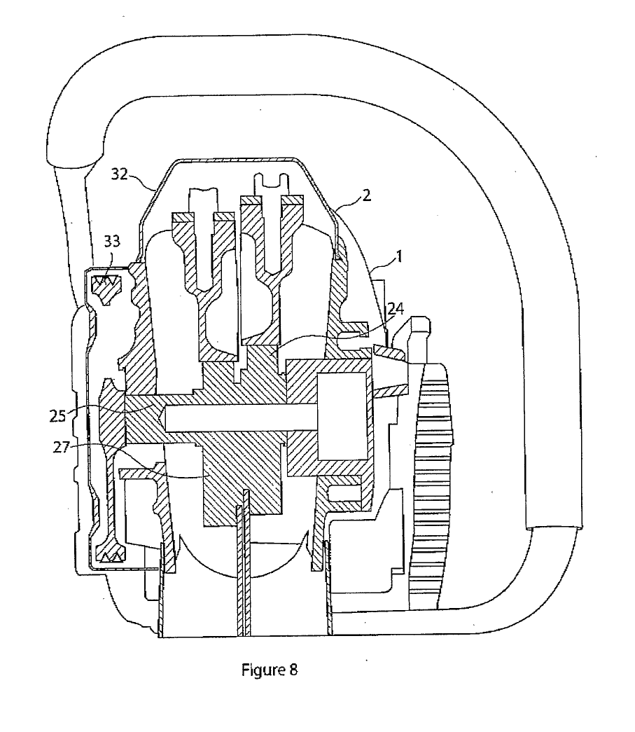

FIG. 8 is a cross sectional view of the parts effecting the respective elliptical drives of the blades but also showing a top portion of the respective jaw parts;

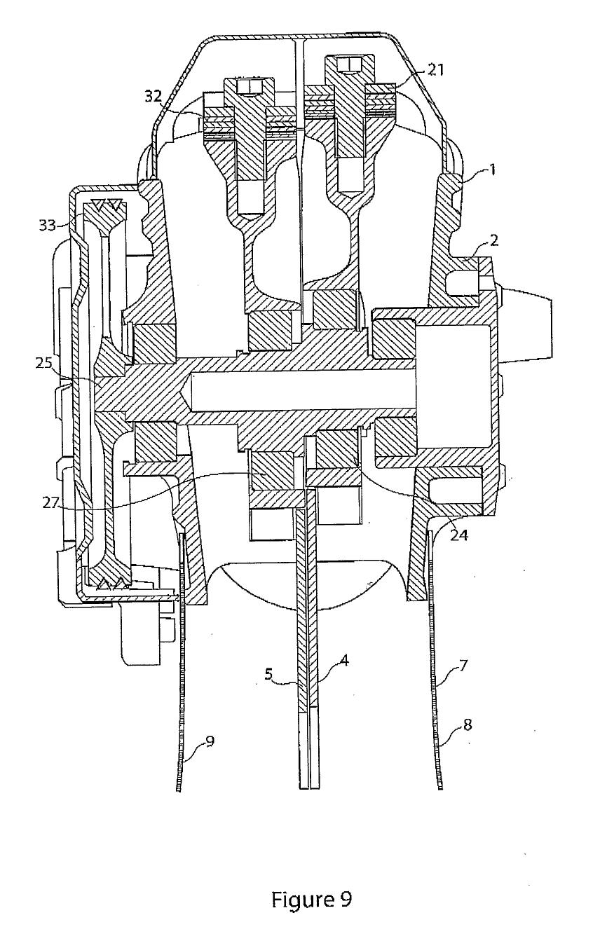

FIG. 9 is an enlarged view of the parts affecting the drive of the blades and also an upper part of the jaw member;

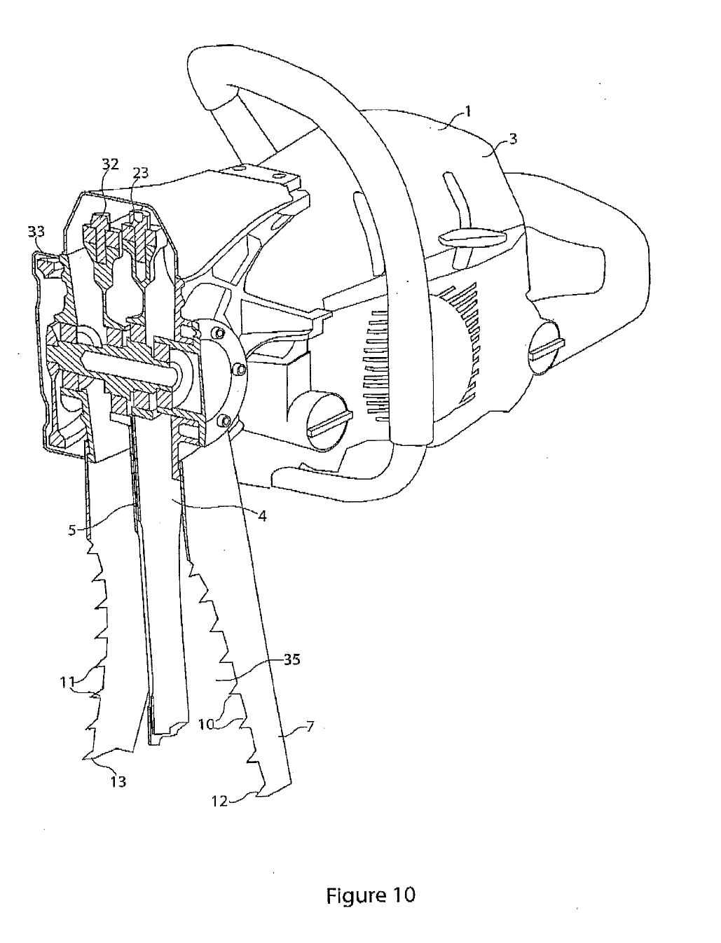

FIG. 10 is a part cut away perspective view showing the operating portions driving the respective blades and also the jaw member providing two jaw parts;

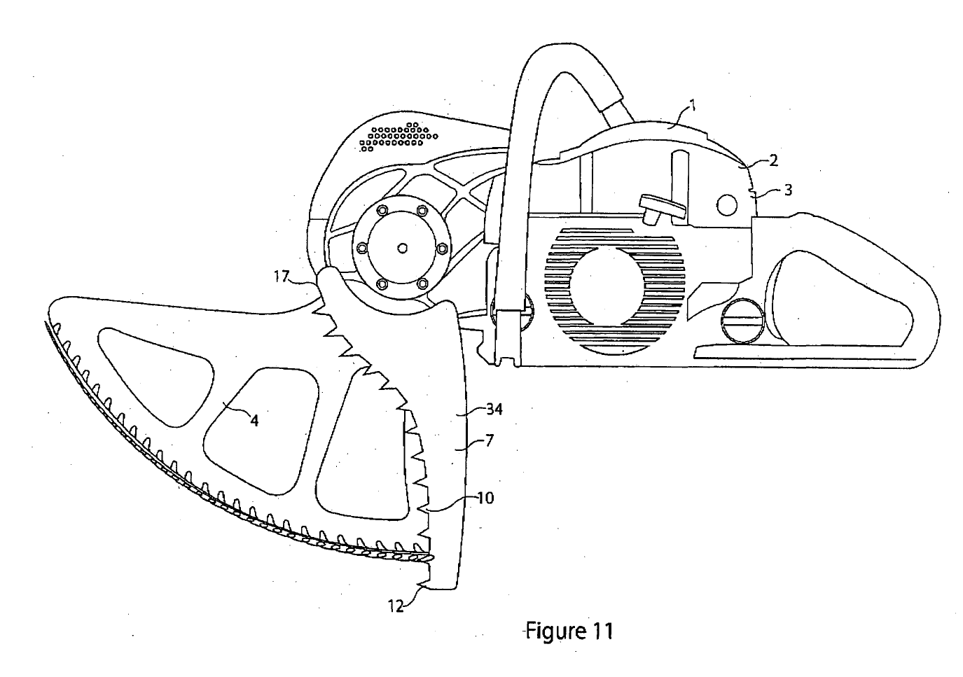

FIG. 11 is a side view of the same embodiment as shown in all the previous figures except in this case, an attempt has been made to illustrate the relative path followed by each of the respective teeth of each blade;

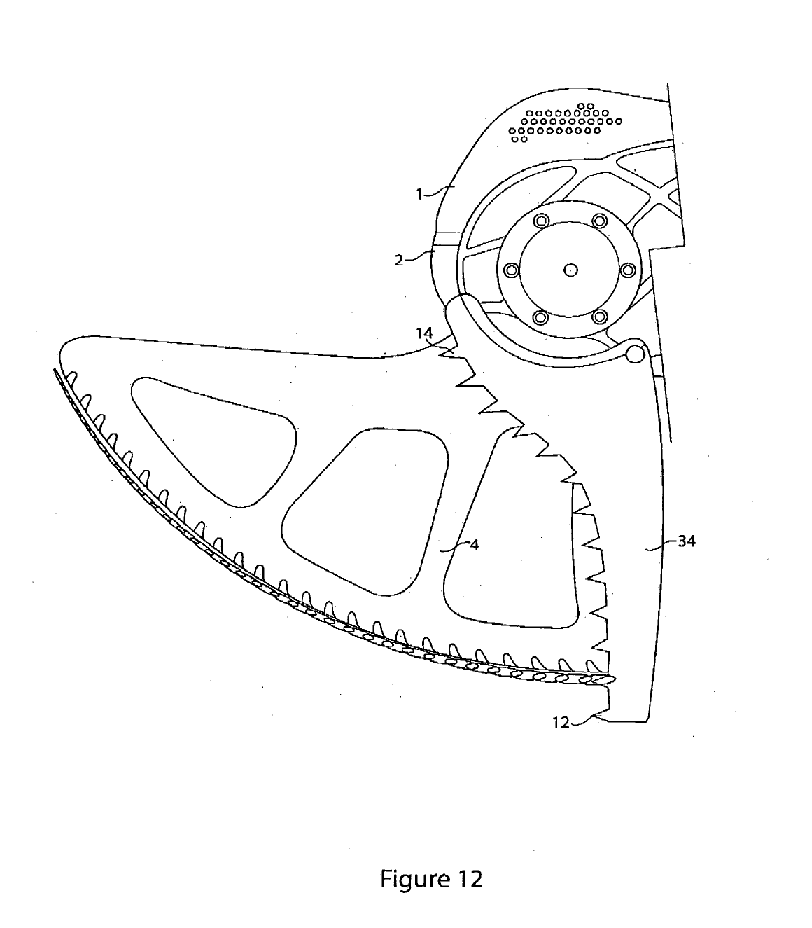

FIG. 12 is an enlarged view of that same figure and in FIG. 11,

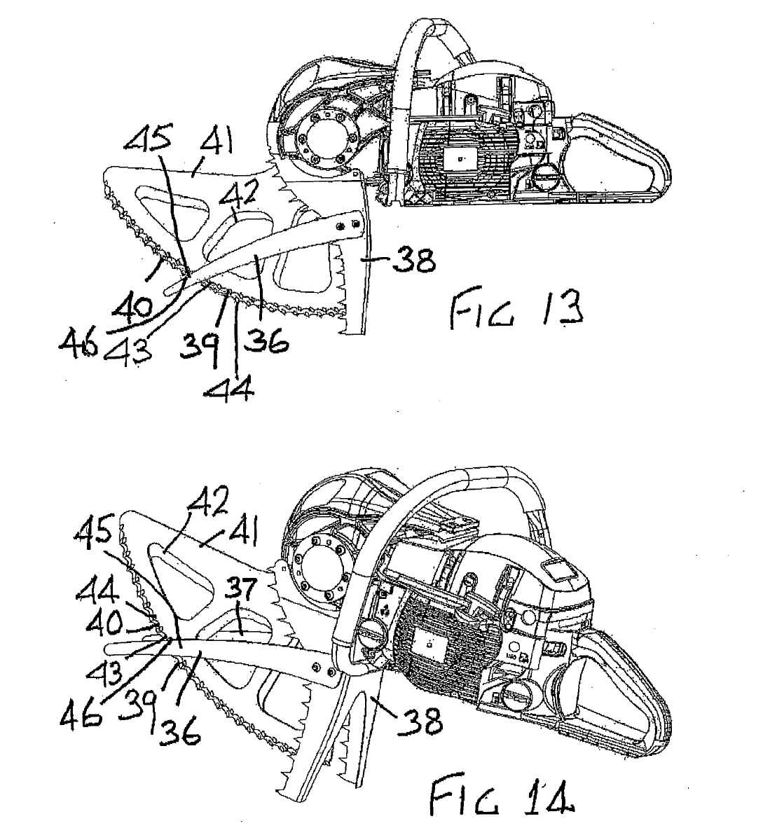

FIG. 13 is a side view of a further embodiment with an alternative anchor locator being in position, and

FIG. 14 is a perspective view of the said further embodiment.

### BEST MODE FOR CARRYING OUT THE INVENTION

Now referring to the drawings and describing the embodiment, the invention in this case relates to locating a jaw or jaws which provide anchor locators to assist in use of the unique cutting action offered by the system of my earlier patent where there are two juxtaposed blades which are caused to move through a path which, by reason of the mechanics and specific linkages, move alternatively in a forward out in a retracted position then back with a cutting action because of a projecting position through a cutting path.

We have referred to this as being somewhat elliptical but it is to be understood that the actual path itself is quite a complex shape and is not intended and should not be considered as necessarily elliptical in a most general sense.

The drive system uses an innermost link to a body and then at a further outer point, effects movement of an axis at this further location which is circular.

In so far that a blade is then held and caused to follow this particular pathway, the result is that at an outer periphery there are cutting teeth outwardly projecting and orientated so that they have a cutting edge which will effect the cutting effect in relation to the work piece when the path of a respective tooth is caused to proceed along an outer projecting cutting path.

Now referring specifically to the drawings, there is a cutting apparatus 1 which includes a body 2, an engine 3. Juxtaposed blades 4 and 5 are supported so as to be able to be driven by the motor 3 so as to effect the respective travel of teeth 6 so that they act so that as one set of teeth are projected forwardly and then along in a cutting action, the other set of teeth are withdrawn and returning retracted from a cutting action to a position to recommence an outwardly projecting cutting action.

The mechanism by which the blades and therefore the teeth are caused to move will be later more fully explained and shown but it will be observed especially in FIGS. 11 and 12 that the paths of the teeth change from a forward or toe position of the blades to a base position of the blades where, if we were talking a pure ellipse, the size of a minor axis would be less at the toe than at the base.

We now have however a jaw 7 which has two parts 8 and 9 which provide therefore on each side of the blades 4 and 5, forwardly projecting teeth shown typically at 10 and 11.

More specifically, at least one of the teeth on each side in this case 12 and 13, is positioned to have its sharp point beyond a periphery of the cutting periphery of the blades 4 and 5 (this means that when viewed directly from a side of the blades the tooth is seen to be beyond the periphery of the blades and especially the cutting teeth of the blades). Further, this tooth is shaped so that it has relatively sharply inclined sides and of equal alignment or angle with relation to a direction which is parallel to the major axes of a path that the closest of the teeth would follow.

The reason for this and the advantage of this will be later explained.

Further inboard, there is a progression of teeth ending in a tooth 14 which is closest to the body 2 as compared to the remainder of the teeth but which again is a sharp tooth with sides inclined to perhaps 15° to a central axis and this central axis passing through a base in the apex so as to be at right angles to the path of teeth that are located generally directed in front of that tooth.

This alignment is best shown in FIGS. 3 and 4 where there can be seen an alignment 15 of the paths of closest teeth to tooth 12 and the alignment 16 which passes generally perpendicularly through the tooth 12 through its apex which alignment is then parallel to this alignment 15.

The alignment of the remaining teeth between the outer tooth 12 in the one case and 13 in the other and an inner tooth 17 at least on one side, are intended then also inboard with relation to the outer cutting teeth of the respective juxtaposed blades 4 and 5. They are also aligned so that they sequentially will be directed to in each case a further path area of the cutting teeth further outward than those of the respective blades.

The mechanism by which the respective blades 4 and 5 are caused to move is shown in greater detail in other drawings for instance FIG. 5 where it is seen that the blades 4 and 5 are secured so that they lie in juxtaposed position and are supported respectively by a support structure 20 which is supported at its upper end by a flexible blade 21 which is secured to the body at 22 and is secured to the structure at 23.

This then acts as a tethered link which confines the locality at 23 to a path that is defined by possible movement of the blade or flexible link 20.

There is then also a rotating drive 24 which is off-centre from a drive axis which is perhaps easiest seen in FIG. 7 at 25.

The respective blades 4 and 5 are each rotatably affixed to the off-centre drives 24 as previously described and 27 which are 180° out of alignment.

The description applies thus far to 4 but is likewise the same drive mechanism for 5 where there is a blade 30 acting as a tethering link to the body location 31 and this being at its outer end joined to a drive structure 32 which itself is driven by being rotatably coupled to the off-centre drive 27 which in turn is rotated by being coupled to the axis 25 which again then is coupled to pulley 33.

As has been previously clarified, this mechanism is not of itself new but it is being assisted in its use by the improvement of this invention.

Further to the above, the jaw 7 in the embodiment is manufactured as a single unit and has a back 34 with an open arch portion 35 and to each side a forwardly directed portion which provides on its forward outer edge the plurality of teeth which have been previously described.

Also as previously described, each of the teeth are shaped to point in a direction which is useful in relation to the anchoring location appropriate for its position.

As the blades 4 and 5 cut deeper into say a wooden piece, it is then possible for teeth further inboard from the periphery of the cutting teeth to be engaged against the edge of a work piece and provide the ensnarement or positive engagement into the wood or in the case of masonry, masonry. This also offers more of the toe end teeth to provide the cutting effect to a cutting surface and these are those with a shallower projection and therefore have by reason of the relative position of the respective tooth providing a pivot axis more cutting path distance for less projection. This implicitly provides a higher mechanical advantage for the cutting action.

A further feature of the embodiment as shown is that the jaw member 34 being split into two spread legs, which are positioned wide of the respective blades 4 and 5 and to some extent lower than at least the rear heel of the blades ensures that these jaws can be used to rest the cutting apparatus 1 on the ground or other supporting surface in a stable position with a remainder of the body of the engine 3 also then resting on the ground in a tripod alignment but this of course then acts to keep the cutting edges of the blades clear of having to rest on a surface and perhaps be damaged or blunted.

It is of value to have the legs or jaws acting as legs in this case widely spread and the only limit to this is the extent to which they are providing support for the anchor locators which would usefully engage against a portion of a work piece which therefore requires a work piece to have a width sufficient for this purpose.

While an anchoring locator in one position beyond a periphery of the cutting edges of the respective blades is in one embodiment a sharp point, in a further embodiment shown in FIGS. 13 and 14 this location can be located further 39 and 40 of the blades 41 and 42. Here the relative movement of the teeth 43 and 44 may be close to or tangential to the curve of the respective cutting edges at this location, and an anchoring locator 45 can then be an edge 46 that provides a around the periphery of the cutting edges of the blades. In this case there are two arms 36 and 37 which are secured to respective sides of a jaw 38 to then project forwardly past the peripheral cutting edges rely Lively linear surface which extends approximately at least in a transverse alignment of the path of the respective teeth 42 and 43 of the cutting edges 39 and 40.

From the above, it will be seen that there is provided a very useful addition to a cutting apparatus of unique cutting characteristics which has thus far proved itself to be of great value.

By providing the improvement of the invention, the cutting itself can be of even greater advantage in both cutting of wood, logs, and masonry items.

1. A cutting apparatus of a type where two juxtaposed blades are caused to move through sequential approximately elliptical paths and having teeth at respective outer edges of the two juxtaposed blades, the relatively moving teeth on the edge of the respective blades being adapted to be urged against a surface to be cut, and at least one anchoring locator which is positioned beyond a periphery of the respective blades and thereby adapted to engage with a work piece while it is being cut and provide thereby a potential anchoring position for a work piece.

2. A cutting apparatus as in claim 1 further characterized in that the anchoring locator is provided by a member attached to the body of the apparatus and extending to one side at least of the blades and extending further than the peripheral alignment of a cutting edge of the respective blades, and there being provided at such distal location, an anchoring locator.

3. A cutting apparatus as in claim 1 further characterized in that said anchoring locator is a sharp tooth which is adapted to ensnare and provide a pivot location point by engaging against the work piece as it is being cut by the relatively moving blades.

4. A cutting apparatus as in claim 1, wherein the member includes at least two anchor point locators at least one of which is inboard from adjacent cutting edges of the respective cutting blades.

5. A cutting apparatus as in claim 1, wherein the position of the anchoring locators include a plurality of locators where at least one is beyond the perimeter of the cutting edges of the juxtaposed blades and at least two anchoring locations, which are spaced apart, are located inboard from the cutting edges of the juxtaposed blades.

6. A cutting apparatus as in anyone in claim 1, wherein the anchor locators are provided by two members or two parts of a single member secured to the body but each extending, a first member or part along one side of the blades, and the other member or part to the other side of the blades and each providing mutually aligned anchoring locators.

7. A cutting apparatus as in claim 1, wherein the anchoring locator or locators positioned beyond the periphery of the cutting edges are positioned at or toward one end of the cutting edges of the blade where the major axes of the approximately elliptical path of the respective cutting edges of the blades are approximately aligned with the alignment of the cutting edge.

8. A cutting apparatus as in claim 1, wherein there are provided a plurality of anchor locators which are spaced at spaced apart locations of the member, or each part of the member, extending from an outer locator position with respect to the cutting edges and then extending in a concave alignment with at least a further anchor locator positioned closest to a body of the cutting apparatus and relatively equal distant from the respective two outer end of the cutting edges of each respective blade.

9. A cutting tool having a body, the first blade secured at a first location to a link secured to the body and arranged to allow constrained relative motion to the body, the first blade being further secured to the body by a first pivot connection, which itself is secured to a rotatable drive adapted to provide an oscillatory motion to the blade in a direction co-planar with the plane of the blade relative to the body, the first blade having an outer cutting edge with teeth, the cutting edge being spaced apart from an axis of the rotatable drive, and spaced apart further from said first location, the cutting edge being of convex arcuate shape having an approximate radius with a radial centre being an axis through an outermost position of the central axis of its connection with the rotatable drive, and its extent being from a position approximately aligned with the said first location and the said axis through an outermost position of the central axis of its connection with the rotatable drive, and extending around to approximately a position where it is aligned at approximately 45° to said first radius, a second blade secured at a second location to a second link secured to the body and arranged to allow constrained relative movement to the body, the second blade being further secured to the body by a second pivot connection which itself is secured to a rotatable drive adapted to provide an oscillatory motion to the blade in a direction parallel with the plane of the blade relative to the body, the second blade having an outer cutting edge with teeth, the cutting edge being spaced apart from the axis of the rotatable drive, and spaced apart further from the said second location, the cutting edge being of convex arcuate shape having an approximate radius with a radial centre being the axis through an outermost position of the central axis of its connection with the rotatable drive, and its extent being from a position approximately aligned with the said second location and the said axis through an outermost position of the central axis of its connection with the rotatable drive, and extending around to approximately a position where it is aligned at approximately 45° to the said second radius, the first and second blades being shaped and supported relative to the body so that each cutting surface is restrained to move in an elliptical path the one being with an action that is out of phase compared to the action of the other, and having the cutting edges in a co-operatively mutually aligned cutting relation, a member secured to the body and extending to provide a first anchor locator which is positioned to be further out from the body than the respective cutting edges of the respective adjacent blades.

10. A cutting tool as in claim 9 having further anchor locators positioned closer to the body than the outer cutting edges of the respective blades.

11. A cutting tool comprising two juxtaposed cutting members each having a tooth cutting edge of a substantially same shape and extent, each of said cutting members having a drive portion extending in a direction lateral to the cutting edge, said drive portions being in a juxtaposed relation;
a. a drive means adapted for coupling to a motor and operatively interacting with each said drive portion to impart thereto an eccentric movement in a plane of each respective said drive portion about a common axis, the eccentric movement imparted to the respective drive portions being equal and angularly out of phase; and
b. means to restrain movement of the respective drive portions at a specific location spaced from said common axis to an approximately linear movement in a direction radial to the common axis and to angular movement about a respectively pivot axis parallel to said common axis, whereby in response to activation of the drive means, the cutting edge of each cutting member prescribes, in a plane of the cutting member, simultaneous oscillatory movements in the direction of the cutting edge and in a direction substantially at right angles to the cutting edge, the corresponding movements of the respective cutting members being outer phase, and the teeth of the cutting edge being adapted to each cut when moving individually in one direction in the direction of the extent of the cutting edge, and a member located to a side of the respective cutting members and providing an anchor locator shape
which is positioned beyond the position of the cutting edges of each respective blade.

12. A cutting tool as in the claim 11 further characterized in that there are two members with aligned anchor locating shapes positioned one to each side of the blades.

13. (canceled)

14. A cutting apparatus as in claim 2 further characterized in that said anchoring locator is a sharp tooth which is adapted to ensnare and provide a pivot location point by engaging against the work piece as it is being cut by the relatively moving blades.

15. A cutting apparatus as in claim 2, wherein the member includes at least two anchor point locators at least one of which is inboard from adjacent cutting edges of the respective cutting blades.

16. A cutting apparatus as in claim 2, wherein the position of the anchoring locators include a plurality of locators where at least one is beyond the perimeter of the cutting edges of the juxtaposed blades and at least two anchoring locations, which are spaced apart, are located inboard from the cutting edges of the juxtaposed blades.

17. A cutting apparatus as in anyone in claim 2, wherein the anchor locators are provided by two members or two parts of a single member secured to the body but each extending, a first member or part along one side of the blades, and the other member or part to the other side of the blades and each providing mutually aligned anchoring locators.

18. A cutting apparatus as in claim 2, wherein the anchoring locator or locators positioned beyond the periphery of the cutting edges are positioned at or toward one end of the cutting edges of the blade where the major axes of the approximately elliptical path of the respective cutting edges of the blades are approximately aligned with the alignment of the cutting edge.

19. A cutting apparatus as in claim 2, wherein there are provided a plurality of anchor locators which are spaced at spaced apart locations of the member, or each part of the member, extending from an outer locator position with respect to the cutting edges and then extending in a concave alignment with at least a further anchor locator positioned closest to a body of the cutting apparatus and relatively equal distant from the respective two outer end of the cutting edges of each respective blade.
